(19) United States
(12) Patent Application Publication
(10) Pub. No.: US 2002/0040044 A1
(43) Pub. Date: Apr. 4, 2002

(54) Pesticidal aqueous suspension concentrates

(76) Inventor: Christian Schlatter, Greensboro, NC (US)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 09/881,284

(22) Filed: Jun. 14, 2001

Related U.S. Application Data
(63) Continuation of application No. PCT/EP99/09987, filed on Dec. 15, 1999.

(30) Foreign Application Priority Data
Dec. 17, 1998 (GB) 98811239.7
Jan. 14, 1999 (GB) 9900758.5

(51) Int. Cl. A01N 43/64

(52) U.S. Cl. 514/383; 514/254.06

(57) ABSTRACT

The invention reltaes to pesticidal compositions in form of aqueous suspension concentrates, comprising a triazole fungicide which is substantially insoluble in water and solid at 25° C., and comprising as surfactants

(1) a tristyrylphenol-ethoxylate or its sulfate or phosphate, in combination with either

(2a) a vinylpyrrolidon homopolymer, or

(2b) a vinylpyrrolidon/styrene blockpolymer, or

(2c) a hydrophilic ethylene oxide-propylene oxide blockpolymer, or with a mixture thereof; and use of the combination of these surfactants for the prevention of crystal growth of the triazole fungicide.

The present invention relates to pesticidal compositions in form of aqueous suspension concentrates, comprising a triazole fungicide which is substantially insoluble in water and solid at 25° C., and comprising as surfactants

(1) a tristyrylphenol-ethoxylate or its sulfate or phosphate, in combination with either

(2a) a vinylpyrrolidon homopolymer, or

(2b) a vinylpyrrolidon/styrene blockpolymer, or

(2c) a hydrophilic ethylene oxide-propylene oxide blockpolymer, or with a mixture thereof.

The invention also relates to the use of these combinations of surfactants for the prevention of crystal growth of the triazole fungicide on storage of the suspension concentrates.

It is common practice to formulate solid, substantially water insoluble pesticides in form of aqueous suspensions. Such suspension concentrates are very sensible systems regarding physical and chemical stability. A particular problem is the crystal growth, e.g. by “Oswald ripening” of the active ingredient during relatively short time of storage. Crystal growth by “Oswald ripening” generally occurs when smaller crystals (which have a larger total area than bigger crystals) dissolve in the aqueous phase and then the material is transported through the continuous phase, to nucleation sites of the bigger crystals.

As a result, the crystals of the active ingredient may aggregate and sediment, the formulation becomes inhomogeneous; during application, filters and nozzles of the spray equipment can block and the biological efficacy may be reduced. Several compounds have been proposed as crystallization and/or crystal growth inhibitors, e.g. alkylcarboxylic acid dimethylamides (U.S. Pat. No. 5,206,225), ethylene oxide-propylene oxide blockpolymers and polyaryl phenol-ethoxylate (EP-A-261,492) and mixtures with polyvinylpyrrolidone (EP-A-592,880). Also distyryl-phenyl-triglykolether has been proposed (EP-A-392,171).

However, the known crystal growth inhibitors do not always satisfy the needs of agricultural practice in all incidents and aspects; either they are not suitable for many particular active ingredients and formulation types or they have to be combined with other, less favorable dispersing or suspending agents or adjuvants. It is therefore a need for further crystal growth inhibitors.

The crystal growth inhibitors provided herewith are particularly suitable for triazole fungicides which are substantially insoluble in water and solid at 25° C. They are readily available, easy to handle, relatively not toxic and have no undesired effects on plants. No or only small amounts of other dispersing agents are necessary for stabilizing the suspension. The compositions according to the invention are stable for at least 12 months at 25° C., without any crystal growth of active ingredient. After dilution with water, the spray mixture is applied without any technical problems and exhibiting full biological efficacy.

The surfactants which prevent crystal growth according to the invention are described in detail as follows:

(1) The tristyrylphenol-ethoxylates have the general formula

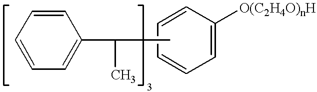

and are in practice mixtures of several compounds which differ by the degree and position of substitution of the phenyl ring and the number of ethoxylate units; the indicated numbers are thus average values. Typically are 8-40 mol, preferably 10-20 and most preferred 14-18 mol ethoxylate.

Suitable salts of the a tristyrylphenol-ethoxylate sulfate or phosphate are, for example, metal salts, such as alkali metal or alkaline earth metal salts, for example sodium, potassium calcium or magnesium salts, or salts with ammonia or an organic amine, such as morpholine, piperidine, pyrrolidine, a mono-, di- or tri-lower alkylamine, for example ethyl-, diethyl-, triethyl- or dimethyl-propylamine, or a mono-, di- or tri-hydroxy-lower alkylamine, for example mono-, di- or tri-ethanolamine.

Preferred are salts with ammonia, amines, as triethylamine and triethanolamine, calcium, potassium and sodium.

(2a) Vinylpyrrolidon homopolymers have the general formula

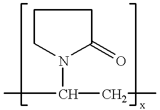

and have an average molecular weight of 5000-3,000,000, preferably of 15,000-500,000, more preferably 50,000-100,000 Daltons.

(2b) Vinylpyrrolidon/styrene blockpolymers have the general formula

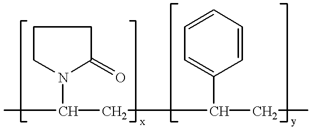

and have an average molecular weight of 5000-3,000,000, preferably of 15,000-500,000, more preferably 50,000-100,000 Daltons.

(2c) Hydrophilic ethylene oxide-propylene oxide blockpolymer have the general formula

(EO)ₓ-(PO)_{y}-(EO)_{z}

wherein EO means ethylene oxide and PO means propylene oxide, and wherein the weight ratio EO:PO is at least 50%, having an average molecular weight of of 1,000-30,000, preferably of 1000-20,000 Daltons.

Molecular weight is to be understood as weight average.

Preferred combinations of surfactants are

a) a tristyrylphenol-ethoxylate having 10-20 mol ethoxylate or its sulfate or phosphate (1) and a vinylpyrrolidon homopolymer (2a);

b) a tristyrylphenol-ethoxylate having 10-20 mol ethoxylate or its sulfate or phosphate (1) and a vinylpyrrolidon/styrene blockpolymer (2b);

c) a tristyrylphenol-ethoxylate having 10-20 mol ethoxylate or its sulfate or phosphate (1) and a hydrophilic ethylene oxide-propylene oxide blockpolymer (2c).

Fungicides which are substantially insoluble in water means their solubility at room temperature is less than 1%, preferably less than 0.1% per weight. Such fungicides are described in “The Pesticide Manual, 11 ht Edition, British Crop Protection Council, 1997”.

Examples of triazole fungicides, which are substantially insoluble in water and solid at 25° C., are penconazole, cyproconazole, tebuconazole, hexaconazole, flusilazole, metconazole and epoxyconazole; preferred are cyproconazole and penconazole, particularly penconazole.

The composition may comprise additional pesticides, which are not triazole fungicides, but which preferably also fungicides.

Such fungicides which may be present in the composition according to the invention are azoles, as imazalil, pefurazoate, pyrifenox, prochloraz; pyrimidinyl carbinoles, as ancymidol, fenarimol, nuarimol; 2-amino-pyrimidines, as bupirimate, dimethirimol, ethirimol; morpholines, as dodemorph, fenpropidin, fenpropimorph, spiroxamin, tridemorph; anilinopyrimidines, as cyprodinil, mepanipyrim, pyrimethanil; pyrroles, as fenpiclonil, fludioxonil; phenylamides, as benalaxyl, furalaxyl, metalaxyl, R-metalaxyl, ofurace, oxadixyl; benzimidazoles, as benomyl, carbendazim, debacarb, fuberidazole, thiabendazole; dicarboximides, as chlozolinate, dichlozoline, iprodione, myclozoline, procymidone, vinclozolin; carboxamides, as carboxin, fenfuram, flutolanil, mepronil, oxycarboxin, thifluzamide; guanidines, as guazatine, dodine, iminoctadine; strobilurines, as azoxystrobin, kresoxim-methyl, SSF-1 26 (metominostrobin or fenominostrobin; SSF-129 (α-methoximino-N-methyl-2-[(2,5-dimethylphenoxy)methyl]benzeneacetamide), trifloxystrobin (2-[α-{[(α-methyl-3-trifluormethyl-benzyl)imino]-oxy}-o-tolyl] -glyoxylsäure-methylester-O-methyloxim); dithiocarbamates, as ferbam, mancozeb, maneb, metiram, propineb, thiram, zineb, ziram; N-halomethylthiodicarboximides, as captafol, captan, dichlofluanid, fluoromide, folpet, tolyfluanid; copper compounds, as bordeaux-mixture, copper hydroxide, copper oxychloride, copper sulfate, cuprous oxide, mancopper, oxine-copper; nitrophenol-derivatives, as dinocap, nitrothal-isopropyl; organo-P-derivatives, as edifenphos, iprobenphos, isoprothiolane, phosdiphen, pyrazophos, tolclofos-methyl; other compounds, as acibenzolar-S-methyl, anilazine, blasticidin-S, chinomethionat, chloroneb, chlorothalonil, cymoxanil, dichlone, diclomezine, dicloran, diethofencarb, dimethomorph, dithianon, etridiazole, famoxadone, fentin, ferimzone, fluazinam, flusulfamide, fenhexamid, fosetyl-aluminium, hymexazol, kasugamycin, methasulfocarb, pencycuron, phthalide, polyoxins, probenazole, propamocarb, pyroquilon, quinoxyfen, quintozene, sulfur, triazoxide, tricyclazole, triforine, validamycin.

The most preferred of these additional fungicides is quinoxyfen.

Preferred mixtures of fungicides are penconazole/quinoxyfen and penconazole/cyproconazole.

Suitable concentrations in relation to the composition are (% weight /weight):

1 to 95%, preferably 2-75%, more preferably 5-30% by weight of a triazole fungicide,

3 to 90%, preferably 20-85% by weight of water,

0.5 to 40%, preferably 1-20%, more preferably 2-7% by weight of combination of surfactants (1), (2a), (2b) and/or (2c).

Suitable ratios of surfactant (1): surfactant (2a), (2b) and/or (2c) are 1:20 to 10:1, 1:10 to 5:1 and 1:5 to 2:1.

The composition according to the invention may comprise additional adjuvants, wetting, dispersing and emulsifying agents, organic solvents, cosolvents and oils, as (in % by weight)

a dispersing agent, 0 to 20%, preferably 0.5 to 5%, e.g. fatty alcohole ethers, fatty acid esters, arylsulfonates as polynaphtalensulfonate, alkylarylsulfonates as dodecylbenzene sulfonate, alkylsulfonates as sodium sulfosuccinate, polyalkyleneglycol ethers, acrylic Graft Co-Polymer, N-methly-N-oleyl-taurin Na salt or polyvinylalkohol;

a thickening agent, 0 to 2%, preferably 0.1 to 1%, e.g. xanthan gum, heteropolysaccharides, oxypropylated cellulose, precipitated or fused silica (hydrophobizised or non-hydrophobizised), gelatine, polysaccharides, tetramethyl decyne diol, ethoxylated dialkyl phenol, methylated clay, propylene carbonate, hydrogenated castor oil, ethoxylated vegetable oil, sodium benzoate or hexanediol;

an antifreeze agent, 0 to 20%, preferably 1 to 10%, e.g. 1,2-propyleneglycol, glycerine, ethyleneglycol or freezing point-lowering salts;

a defoaming agent, 0 to 5%, preferably 0.1 to 2%, e.g. silicone oil, alcohols, fluoroorganics or mineral oils;

a preservative/biocide, 0 to 10%, preferably 0.1 to 3% , e.g. formaldehyde, 1,2 benzisothiazol-3(2H)-one or its salts, or benzoic acid;

a buffer. 0 to 5%, preferably 0.1 to 3%, e.g. acetic acid (AcOH)/NaOH or AcOH/KOH, H₃PO₄/NaOH or H₃PO₄/KOH, citric acid/NaOH or citric acid/KOH, or KH₂PO₄/Borax;

an adjuvant to raise the biological availability and efficacy, 0 to 30%, preferably 10-20%, e.g. alcohol ethoxylates, amine ethoxylates, ethylene oxide-propylene oxide blockpolymers, alcohol sulfates, alkylaryl sulfonates, alkylsulfonates, alkylphenol ethoxylates, ester ethoxylates, castor oil ethoxylates and alkanol amides.

Suitable water-immiscible solvents are aliphatic and aromatic hydrocarbons such as hexane, cyclohexane, benzene, toluene, xylene, mineral oil or kerosin, mixtures of substituted naphthalenes, mixtures of mono- and polyalkylated aromatics, halogenated hydroarbons such as methylene chloride, chloroform and o-dichlorobenzene; phthalates, such as dibutyl phthalate or dioctyl phthalate; ethers and esters, such as ethylene glycol monomethyl or monoethyl ether; fatty acid esters; ketones, such as cyclohexanone; pyrrolidones, such as N-octyl-2-pyrrolidone; plant oils such as castor oil, soybean oil, cottonseed oil and possible methyl esters thereof; as well as epoxidised coconut oil or soybean oil.

Suitable water-miscible solvents are e.g. alcohols and glycols, such as ethanol, ethylene glycol, strongly polar solvents, such as N-methyl-2-pyrrolidone, tetramethylurea, gamma-butyrolacone,dimethyl sulfoxide, N,N-dimethylacetamid and dimethylformamide.

Another object is a process for preparing a composition as herein described, by grinding or milling the solid pesticide and then intimately mixing, optionally by warming, the components, until a homogeneous phase is achieved. Alternatively, the components may first be mixed and subsequently grinded and milled.

In another aspect of the invention the composition is an aqueous spray mixture. Before the application, the composition of the invention may be diluted with water by simply mixing at ambient temperature in order to get a ready for use spray mixture. The resulting spray mixtures are stable, i.e. they remain as a homogeneously dispersed phase on standing without agitation for at least one hour to 12 hours or even more. Preferred concentrations of the spray mixture are 0.1 to 10%, more preferred 0.2 to 5% pesticide in relation to the spray mixture.

A further aspect of the invention is a method of preventing or combating undesirable plant growth, infestation of plants or animals by pests and regulating plant growth by diluting the composition according to claim 1 with water and applying a pesticidally effective amount to the cultivation area, to the plant or animal.

### PREPARATION EXAMPLES

The following Examples illustrate the invention in more detail. The registered trademarks and other designations denote the following products:

The suppliers are known or may easily be found, e.g. in “McCutcheon's Emulsifiers and Detergents”, Rock Road, Glen Rock, N.J. 07452-1700, USA, 1997.

| | | |
|---|---|---|
| Soprophor 4D384 | Tristyrylphenol-16 EO sulfate | surfactant (1) |
| | ammonium salt | |
| Sokalan HP 53 | vinylpyrrolidon homopolymer | surfactant (2a) |
| | MW 50′000-60′000 | |
| Agrimer ST | vinylpyrrolidon/styrene | surfactant (2b) |
| | blockpolymer | |
| Pluronic P 105 | EO-PO-EO block-copolymer | surfactant (2c) |
| Pluronic P 108 | | |
| Pluronic P 65 | | |
| Morwet D-425 | Na-Polynaphtalenesulfonat | dispersing agent |
| Atlox 4894 | Polyalkyleneglycol ether/alcohol | |
| | EO | |
| Atlox 4913 | Acrylic Graft Co-Polymer | |
| Kelzan | Polysacoharid | thickener |
| Rhodopol 23 | Polysaccharid | |
| Avicel CL 611 | Mikrocryst. cellulose. | |
| Foammaster UDB | Polydimethylsiloxan | defoaming agent |
| Silicone A | | |
| Proxel GXL | 1,2-benzisothiazol Na salt | preservative/ |
| | | biocide |

EO = ethylene oxide; PO = propylene oxide; MW = molecular weight

The components are intimately mixed, optionally by warming, until a homogeneous phase is achieved.

The average size of the suspended particles is 2-3 microns when measured with a laser particle analyzer, e.g a CILAS 920 apparatus.

The compositions according to the examples are stable for at least 1 month at 40° C. or 12 months at 25° C. without crystal growth of active ingredient.

After diluting with water the compositions form ready to use spray mixtures which are applied without any technical problems and exhibiting full biological efficacy.

The numbers given in the Examples are concentrations in % weight/weight.

### Example 1

| | % w/w | | | | | | |
|---|---|---|---|---|---|---|---|
| component | 1a | 1b | 1c | 1d | 1e | 1f | 1g |
| Penconazole techn. | 10 | 10 | 10 | 10 | 20 | 20 | 20 |
| (fungicide) | | | | | | | |
| Cyproconazole techn. | — | — | — | — | 10 | 10 | 10 |
| (fungicide) | | | | | | | |
| Soprophor 4D384 | 1.5 | 1 | 1.5 | 2 | 1.5 | 2 | 1.5 |
| (surfactant (1)) | | | | | | | |
| Sokalan HP 53 | 3 | — | — | — | 3 | — | — |
| (surfactant (2a)) | | | | | | | |
| Agrimer ST | — | 3 | — | — | — | — | 3 |
| (surfactant (2b)) | | | | | | | |
| Pluronic P 105 | 3 | 5 | 3 | — | — | 1 | — |
| (surfactant (2c)) | | | | | | | |
| Pluronic P 108 | — | — | — | 2 | — | 1 | — |
| (surfactant (2c)) | | | | | | | |
| 1,2 Propyleneglycol | 3 | 3 | 3 | 3 | 3 | 3 | 3 |
| Proxel GXL | 0.03 | 0.03 | 0.03 | 0.03 | 0.03 | 0.03 | 0.03 |
| Silicone A | 0.2 | 0.2 | 0.2 | 0.2 | 0.2 | 0.2 | 0.2 |
| Kelzan | 0.25 | 0.25 | 0.25 | 0.25 | 0.25 | 0.25 | 0.25 |

| | |
|---|---|
| Water | ad 100 |

### Example 2

| | % w/w | | | | | | | |
|---|---|---|---|---|---|---|---|---|
| component | 2a | 2b | 2c | 2d | 2e | 2f | 2g | 2h |
| Penconazole | 10 | 10 | 10 | 10 | 10 | 10 | 10 | 10 |
| techn. | | | | | | | | |
| Quinoxyfen | 21 | 21 | 21 | 21 | 21 | 21 | 21 | 21 |
| tech. | | | | | | | | |
| Soprophor | 1.50 | 1.50 | 2 | 1.50 | 1.50 | 1.50 | 1 | 3 |
| 4D384 | | | | | | | | |
| (surfactant (1)) | | | | | | | | |
| Sokalan HP 53 | — | — | — | 3.00 | 5.00 | 2.50 | 1 | 2.5 |
| (surfactant | | | | | | | | |
| (2a)) | | | | | | | | |
| Agrimer ST | 3.00 | 3.00 | 4.5 | — | — | 2.50 | 1.5 | — |
| (surfactant | | | | | | | | |
| (2b)) | | | | | | | | |
| Avicel CL 611 | 0.20 | 0.20 | 0.20 | 0.20 | 0.20 | 0.20 | 0.20 | 0.20 |
| Morwet D-425 | 0.8 | 0.8 | 0.8 | 0.8 | 0.8 | 0.8 | 0.8 | 0.8 |
| 1,2 Propylen- | 5.0 | 5.0 | 5.0 | 5.0 | 5.0 | 5.0 | 5.0 | 5.0 |
| glycol | | | | | | | | |
| Atlox 4894 | 0.50 | — | — | — | — | — | — | — |
| Atlox 4913 | 1.50 | — | — | — | — | — | — | — |
| Proxel GXL | 0.08 | 0.08 | 0.08 | 0.08 | 0.08 | 0.08 | 0.08 | 0.08 |
| Silicone A | 0.25 | 0.25 | 0.25 | 0.25 | 0.25 | 0.25 | 0.25 | 0.25 |
| Kelzan | 0.15 | 0.15 | 0.15 | 0.15 | 0.15 | 0.15 | 0.15 | 0.15 |
| Foammaster | 0.05 | 0.05 | 0.05 | 0.05 | 0.05 | 0.05 | 0.05 | 0.05 |
| UDB | | | | | | | | |

| | |
|---|---|
| Water | ad 100 |

### Example 3

| | % w/w | | | | | |
|---|---|---|---|---|---|---|
| component | 3a | 3b | 3c | 3d | 3e | 3f |

| | | | | | | |
|---|---|---|---|---|---|---|
| Penconazole techn. | 10 | 10 | 10 | 10 | 10 | 10 |
| (fungicide) | | | | | | |
| Quinoxyfen techn. | 21 | 21 | 21 | 21 | 21 | 21 |
| (fungicide) | | | | | | |
| Soprophor 4D384 | 1.5 | 1 | 1.5 | 2 | 1.5 | 2 |
| (surfactant (1)) | | | | | | |
| Pluronic P 105 | 3.0 | 5 | — | — | — | 1 |
| (surfactant (2c)) | | | | | | |
| Pluronic P 108 | — | — | 3.0 | 2 | — | 1 |
| (surfactant (2c)) | | | | | | |
| Pluronic P 65 | — | — | — | — | 3.0 | — |
| (surfactant (2c) | | | | | | |
| Avicel CL 611 | 0.20 | 0.20 | 0.20 | 0.20 | 0.20 | 0.20 |
| Morwet D-425 | 0.8 | 0.8 | 0.8 | 0.8 | 0.8 | 0.8 |
| 1,2 Propylenglycol | 5.0 | 5.0 | 5.0 | 5.0 | 5.0 | 5.0 |
| Proxel GXL | 0.08 | 0.08 | 0.08 | 0.08 | 0.08 | 0.08 |
| Silicone A | 0.25 | 0.25 | 0.25 | 0.25 | 0.25 | 0.25 |
| Kelzan | 0.15 | 0.15 | 0.15 | 0.15 | 0.15 | 0.15 |
| Foammaster UDB | 0.05 | 0.05 | 0.05 | 0.05 | 0.05 | 0.05 |

| | |
|---|---|
| Water | +TC,10/32 ad 100 |

### Comparison Examples

Without either of the surfactant combinations (1) with (2a), (2b) and/or (2c) in the formulation, crystals of the active ingredient grow up to an average of 10 microns and more within a few months at 20-25° C., thus rendering the application of the spray mixture by a spray device difficult.

1. A pesticidal composition in form of an aqueous suspension concentrate, comprising a triazole fungicide which is substantially insoluble in water (<1% at room temperature) and solid at 25° C., and comprising as surfactants
(1) a tristyrylphenol-ethoxylate or its sulfate or phosphate, in combination with either
(2a) a vinylpyrrolidon homopolymer, or
(2b) a vinylpyrrolidon/styrene blockpolymer, or
(2c) a hydrophilic ethylene oxide-propylene oxide blockpolymer, or with a mixture thereof.

2. A composition according to claim 1, comprising
1 to 95% by weight of a triazole fungicide,
3 to 90% by weight of water,
0.5 to 40% by weight of a combination of surfactants (1), (2a), (2b) and/or (2c).

3. A composition according to claim 1, wherein the ratio of surfactant (1): surfactant (2a), (2b) and/or (2c) is 1:20 to 10:1.

4. A composition according to claim 1, wherein the triazole fungicide is selected from penconazole, cyproconazole, tebuconazole, hexaconazole, flusilazole, metconazole and epoxyconazole.

5. A composition according to claim 1, comprising an additional fungicide other than a triazole fungicide.

6. A composition according to claim 5, wherein the additional fungicide is quinoxyfen.

7. An aqueous spray mixture prepared by diluting the composition according to claim 1 with water.

8. Use of
(1) a tristyrylphenol-ethoxylate or its sulfate or phosphate, in combination with either
(2a) a vinylpyrrolidon homopolymer, or
(2b) a vinylpyrrolidon/styrene blockpolymer, or
(2c) a hydrophilic ethylene oxide-propylene oxide blockpolymer, or with a mixture thereof in a pesticidal composition in form of an aqueous suspension concentrate, comprising a triazole fungicide which is substantially insoluble in water and solid at 25° C., or in an aqueous spray mixture prepared by diluting such composition, for the prevention of crystal growth of the fungicide.

9. A method of preventing crystal growth of a triazol fungicide which is substantially insoluble in water and solid at 25° C., in an aqueous suspension concentrate or in an aqueous spray mixture prepared by diluting such concentrate, wherein
(1) a tristyrylphenol-ethoxylate or its sulfate or phosphate, in combination with either
(2a) a vinylpyrrolidon homopolymer, or
(2b) a vinylpyrrolidon/styrene blockpolymer, or
(2c) a hydrophilic ethylene oxide-propylene oxide blockpolymer, or with a mixture thereof are added to the aqueous suspension concentrate or to the aqueous spray mixture.

10. A method of preventing or combating undesirable plant growth, infestation of plants or animals by pest and regulating plant growth by diluting the composition according to claim 1 with water and applying a pesticidally effective amount to the cultivation area, to the plant or part of plants, or animal.
